(19) United States
(12) Patent Application Publication
(10) Pub. No.: US 2014/0115468 A1
(43) Pub. Date: Apr. 24, 2014

(54) GRAPHICAL USER INTERFACE FOR MIXING AUDIO USING SPATIAL AND TEMPORAL ORGANIZATION

(71) Applicant: BENJAMIN GUERRERO, EL PASO, TX (US)

(72) Inventor: BENJAMIN GUERRERO, EL PASO, TX (US)

(21) Appl. No.: 14/060,399

(22) Filed: Oct. 22, 2013

Related U.S. Application Data
(60) Provisional application No. 61/718,179, filed on Oct. 24, 2012.

(51) Int. Cl. G06F 3/16

(52) U.S. Cl. CPC G06F 3/165
USPC 715/716

(57) ABSTRACT

A system and method incorporating a touch screen that permits the mixing of audio tracks or data using spatial and temporal organization. By organizing audio tracks as images in 2D or 3D space (augmented reality), many tracks can be visualized at the same time and perceived by a user in a visually accurate way. By animating the images based on such characteristics as volume and aural position, images can move out of the way and only relevant audio tracks will be displayed.

### CROSS REFERENCE TO RELATED APPLICATION

The present application claims priority to U.S. Provisional Application Ser. No. 61/718,179, filed on Oct. 24, 2012, the disclosure of which is incorporated herein by reference in it entirety.

### BACKGROUND

Conventional audio recording software use skeuomorphic designs based on analog audio hardware, which causes an inefficient use of screen space and unintuitive organization of large multi-track recordings. Other devices organize tracks numerically and such a representation can be difficult or confusing for users with large multi-track sessions. Also, only so many tracks can be seen at a given time on the computer screen before a user would have to scroll left or right to see more.

Improvements to conventional approaches to visualizing and representing tracks are desirable. Such improvements might be in the form of organizing audio tracks as images in 2D or 3D space (augmented reality) so that many tracks can be seen together at the same time and in a visually accurate way. Such improvements might also include animating the images based on volume and aural position, so that images representing tracks for sounds coming from one direction can move out of the way in the visualization so that only relevant audio tracks will be displayed to a user based on the direction the user is facing.

### BRIEF DESCRIPTION OF THE DRAWINGS

The accompanying drawing figures, which are incorporated in and constitute a part of the description, illustrate several aspects of the present disclosure and together with the description, serve to explain the principles of the present disclosure. A brief description of the figures is as follows:

FIG. 1 is a top plan view of a computing device with a graphical user interface according to the present disclosure illustrating a drag gesture to change a track's stereo pan and a pinch gesture to change the track's gain.

FIG. 2 is a top plan view of the computing device and graphical user interface of FIG. 1 illustrating an animation providing amplitude feedback for a track according to the present disclosure.

FIG. 3 is a top plan view of the computing device and graphical user interface of FIG. 1 illustrating use of a “mute” button with respect to a track, and visual feedback denoting the status for the altered track according to the present disclosure.

FIG. 4 is a perspective view of the computing device and graphical user interface of FIG. 1 illustrating use of the device as part of an augmented reality to visualize a multi-channel audio mix surrounding the user.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

Current audio recording software use skeuomorphic designs based on analog audio hardware, which causes an inefficient use of screen space and unintuitive organization of large multi-track recordings. The system and method of the present disclosure described herein addresses at least these issues. By removing skeuomorphs in audio recording software and incorporating multi-touch gestures, this new design of the present disclosure is more efficient and intuitive for organizing and mixing many audio tracks.

In contrast to conventional approaches to this sort of software and interface, the system and method of the present disclosure permits audio tracks to be mixed or panned by manipulating an image that represents the audio, rather than representing the devices or controls used to mix tracks manually. The system and method can also permit animation of these images to help spatially organize the audio for the benefit of the user.

Conventional audio recording software does not give the user an accurate visualization of the audio mix for stereo or multi-channel output. Nor does the conventional software permit a user to visualize or see a large number of tracks at the same time.

By organizing audio tracks as images in 2D or 3D space (augmented reality), many tracks can be seen at the same time and in a visually accurate way. By animating the images based on volume and aural position, images can move out of the way and only relevant audio tracks may be displayed. Also, the system and method of the present disclosure can be used to aid in the composition of a musical piece that can be copyrighted. It can also be used to create original visual animations for music or audio.

Referring now to the attached FIGS., the system and method of the present disclosure may include the following elements, although it is not intended to limit the present disclosure to this exemplary list of elements:
1. a computing device with audio-input access and audio output capability with a graphical user interface according to the present disclosure
2. a computer-readable digital storage medium accessible to the computing device;
3. audio content in a digital format stored on the digital storage medium
4. a color monitor integrated with or connected to the computing device, the monitor preferably incorporating touch screen technology
5. a computer keyboard may be required for entry of instructions or parameters beyond that which is possible by interaction with visual representations, and it is anticipated that the touch screen may permit the use of a virtual keyboard on the monitor
6. a mouse or other manually manipulable user input device or interface for controlling on-screen cursor activity in addition to the touch screen
7. professional audio recording software to accept the instructions from the graphical user interface for alteration of the characteristics of the audio content from the computing device
8. a gestural input device such as but not limited to a multi-touch capable tablet device 100
9. a wireless router to create network transmitting bi-directionally with the computing device

These elements may be linked in the following non-limiting exemplary fashion:

All computer peripherals (color monitor, computer keyboard, mouse or other manually manipulable input device, along with necessary peripherals to enable perceptible audio output) may be connected to each other either directly or wirelessly as is conventionally known. These devices may also be in communication with, such as by but not limited to the wireless network, to multi-touch tablet device 100. The subject computer-readable medium on tablet 100 may then wirelessly connect with the professional audio recording software and the audio content on the computing device may be manipulated from the tablet.

The present application refers to a general type of input device that responds to manual gestures from a user of the system. While this device may be a touch screen tablet device such as is illustrated in the FIGS., it is not intended to limit the present application to any particular type of gestural input device. Some device may incorporate displays or screens that accept gestural inputs from the user and also display some or all of the icons or other visual representations related to audio tracks as described herein. Other devices within the scope of the present application may merely be sensors that are able to discern manual gestures by a user and translate those gestures into instructions for altering the audio characteristics of an audio track. These such devices may not have any requirement that the user touch them physically. Such devices may or may not include displays. Those devices without displays may serve input devices to permit the movement of a cursor on another screen or monitor as a user accesses and interacts with icons appearing on that screen or monitor.

These elements may operate or function in the following non-limiting fashion:

The system and method of the present disclosure may use a utility such as but not limited to the Open Sound Control protocol to allow tablet 100 to control the professional audio recording software. Once a connection is established between the tablet and the software, an audio track from the digital storage medium may be presented as an iconographic image on the screen of the tablet to represent each audio track. From there, a user may choose to group redundant audio tracks together into one image. For a stereo output, the left side of the screen may represent the left audio output and the right side of the screen may represent the right audio output. The user can move an audio track in stereo space by simply dragging an image around with their finger. In other words, if the image is positioned by the user in the middle of the screen, then the track(s) represented by the image may be balanced between the left and right. If the image is moved by the user toward the left side of the screen, the software would move the balance toward the left. In this way, the user of tablet 100 can arrange the point of origin for all tracks represented in a particular recording to adapt or adjust the music generated when the recording is output through an appropriate stereo output device.

It is anticipated that the relative vertical position of icons on screen as a default may be used to permit the arrangement of icons for simultaneous actions. In other words, if a plurality of tracks were desired to have the same or similar origination point and to be audible at the same time, the vertical positioning of the icons representing these tracks would permit the user to see all of the necessary icons on screen together.

It is further anticipated that the vertical arrangement of icons may be used to designate particular effects to be applied to the track based on its relative or absolute position on the screen. If icons for two tracks are placed generally side by side on screen, with one closer to the top of the screen relative to the other, the same effect may be applied to both tracks with the higher icon having a greater amount applied. Or, it could be that any icon that is placed at a base level on the screen has none of the effect applied while the movement of any track icon above that base level would cause the effect to be applied to that track.

For binaural or multi-channel surround sound output, augmented reality and a gyroscope can be used to virtually place the audio tracks 360 degrees around the user. In other words, if the recording includes sounds which have been recorded in surround sound, then the origin of each track could be adjusted by the tablet device so that it appears to originate from a particular location about the user. The metadata associated with each audio track may need to be modified to incorporate the changes specified by the user through use of the system of the present disclosure. Use of a gyroscope or other similar motion sensing device(s) including but not limited to accelerometers, will permit a user to stand in the center of a space, define where the front center location shall be and then modify various tracks of the recording to originate from a particular direction relative to the front center by turning the tablet in the direction that the sound should appear to be originating.

Further, it is anticipated that the tablet may be configured to only display those tracks which originate from the direction the tablet is being directed or from near that direction. For a recording with a plurality of tracks, this filtering based on direction of origin will permit a user to separate and clearly distinguish tracks visually as the user turns in a circle with the tablet.

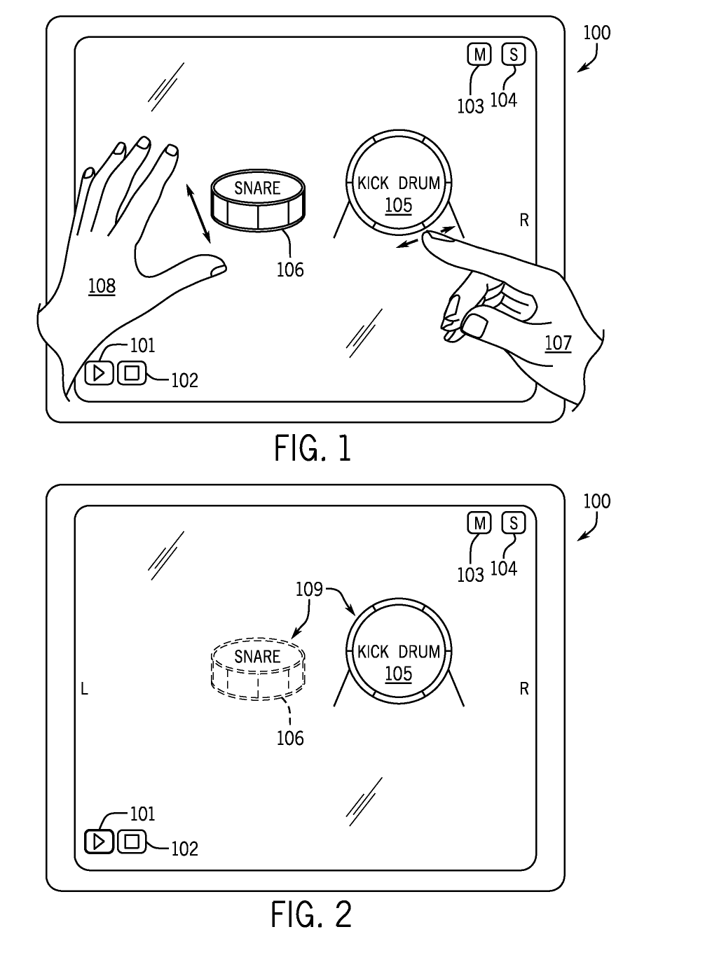

For example, referring now to FIGS. 1 to 3, a user may turn tablet 100 to a direction from which he or she wishes to have the snare and kick drum sounds to be originated. By moving the images associated with these tracks to the middle of the screen, the tablet device may then instruct the professional audio recording software to modify the data relating to the track to make it appear to a listener that the two drums are located in close proximity to each other and in a similar direction from the listener. The audio content on the storage medium could be modified so that when the audio content is played over a stereo or surround sound amplifier and speaker system, the sound generated from these tracks will appear to any listeners to be originating from the desired direction.

Once one or more tracks are positioned on the tablet as desired for the particular sound origination points, the tablet user may then choose to modify the nature of the sounds generated beyond the direction of origin. For example, as shown in FIG. 1, a play button icon 101 and a stop button icon 102 may appear on a screen of tablet 100 and may be used by the user to start and stop the recording from being played. When the recording is being played, the tracks represented on the screen (shown here as kick drum 105 and snare drum 106 icons) may be muted by use of a mute button icon 103 or highlighted in the recording as a solo by use of a solo button icon 104. If the track represented by an icon 105 or 106 on the screen is playing, then the characteristics of the sound may be modified by the user through the use of various hand or finger gestures or movements. For example, the user's right hand may be making a point and drag movement 107 to alter the location of origin for kick drum track icon 105 by moving the icon left or right on the screen. As a further example, the user's left hand may be making a pinching movement 108 to change the gain of the track. It is anticipated that such a pinching movement may alter the size of the icon on screen temporarily to give the user a visual confirmation that the desired action took place with respect to the track but it is also anticipated that the icon will return to an original size after a specified period of time so that all the icons are presented on screen in a consistent fashion. This may help users with the spatial and or temporal organization of the tracks by having consistently sized icons.

Referring now to FIG. 2, the volume of a particular track within a recording relative to other tracks may be graphically illustrated by use of different levels of opacity 109 of the icons. That way, differences in volume levels between tracks can be quickly and easily perceived by the user. Further along this continuum, if a particular track in a recording is muted or not audible at particular points during the playback, then the icon representing the track may disappear from the screen and then reappear when the track becomes audible again. As tracks are raised or lowered in volume, the icon on screen may be altered in opacity to accurately represent the volume level at any moment in time.

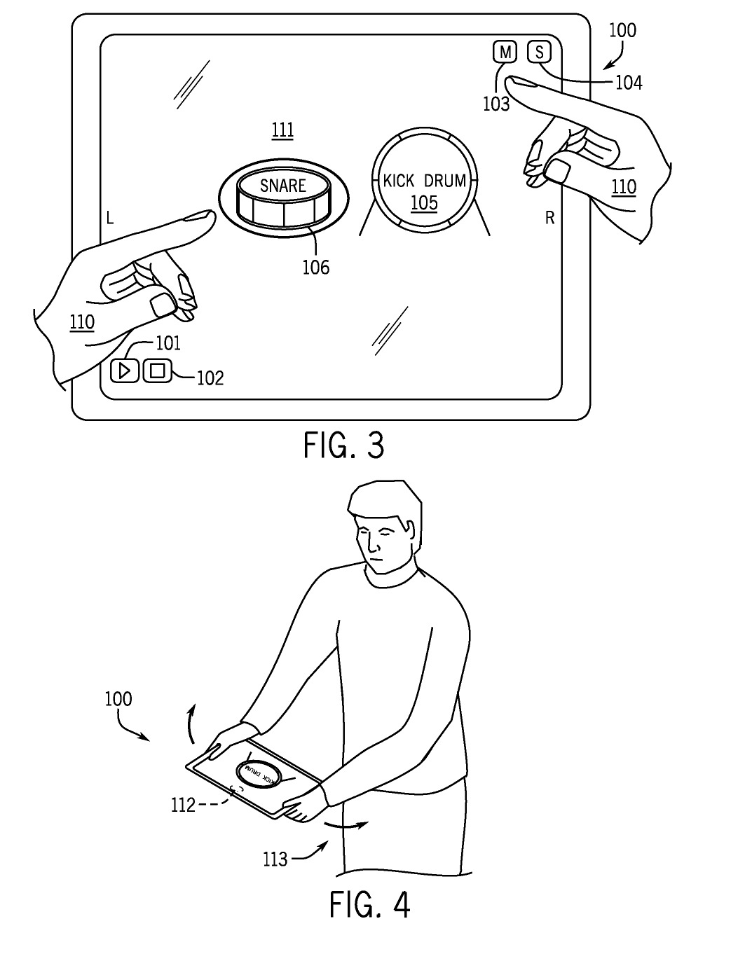

If there are multiple icons and/or tracks represented on screen, the use of any one button to change characteristics may apply those changes to each track on the screen. If the user wished to only modify the characteristics for a subset of the visible tracks, the user may use a point gesture 110 with one hand to select the desired tracks (indicated by a visual feedback such as a circle or oval 111 about the icon(s) on the screen or some other manner of visually indicated the selected tracks) and a point gesture 110 with the other hand to make the desired changes to only those selected tracks, as illustrated in FIG. 3.

Referring now to FIG. 4, a movement and/or direction sensing device such as but not limited to a gyroscope, accelerometer, or other suitable device 112 may be incorporated into tablet 100 to permit the user to utilize an augmented visual representation of the location or origin of tracks by swinging the tablet through an arc 113 to see tracks that are panned elsewhere from the current tracks being viewed and/modified. In other words, the system of the present application would provide the ability of a user to be virtually positioned as the center of a space with the various tracks of a recording positioned in the virtual space around the user. By physically or virtually rotating within the space, the user is able to see and manipulate icons for each of the tracks and create a desired audible experience based on those tracks in a more intuitive and visual fashion. Present technology does not provide this sort of immersive visualization and manipulation of tracks.

By using a common gesture such as pinching a screen image of an audio track to make the screen image larger or smaller, the audio track's gain may increase or decrease. There may be a common mute, solo, input enable, and record enable modifier button on the screen of the tablet that can be used to alter each audio track image by simultaneously pressing the audio track image and necessary modifier button. To visually represent the audio waveform, the opacity of each track image can be animated in conjunction with each track's amplitude. Therefore, tracks that are loud may appear dominant on the screen, tracks that are audibly less prominent may be less visually distinct on the screen and tracks that are not playing may temporarily disappear only during playback.

Once the set-up is complete, the user may enable the tablet device to control the professional audio software. Afterwards, the user should perceive the audio track images relative to the audio output coming from the computer.

To make system and method of the present disclosure, one must craft software for a multi-touch device that is able to complete the requisite tasks and provide the user with the useful interface described here above. The multi-touch tablet and audio content are necessary and can be used standalone. Ideally, the tablet will be used in conjunction with a computer to be used in existing audio recording environments, permitting backwards compatibility with conventional software. Theoretically, a virtual reality headset and a multi-touch gesture recognizing device could be used to recreate the same interface.

The system and method of the present disclosure can be used as an alternative mixing interface for audio recording software. In conjunction with professional audio recording software, this system and method may help organize large multi-track sessions. It can also be used by novice audio engineers to help them visualize the audio mix.

Additionally, almost any multi-touch screen or visualization device can be used, not just tablet 100. For example, a touch screen stationary computing device can be used in place of a handheld tablet. As another example, a more traditional desktop or laptop computer can be combined with a virtual reality goggle system that may allow a user to stand in any space and be able to see a visual display about the user of the various tracks and use similar hand gestures to modify tracks within a recording. A user who is more accustomed to traditional mixing boards may not need the virtual reality features but may be able to utilize a three dimensional display or representation on a traditional monitor while manipulating tracks using a mouse or other suitable pointing device. It is anticipated that almost any form of augmented reality or virtual reality displays may also be used in conjunction with any gesture recognition technology. For more complex sound recording having a multitude of tracks, a plurality of screens may be arrayed adjacent to one another to permit a greater portion of the tracks to be simultaneously visualized and manipulated.

It is anticipated that real-time integration of the visualization and track manipulation interface and device with the professional audio software may be desirable to permit rapid manipulated and the manipulated tracks or the entire edited recording played back as part of an iterative editing, mixing or production process. Also, the system and method of the present disclosure can be used to aid in the composition of a musical piece that can be copyrighted. It can also be used to create original visual animations for music or audio.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A system for visualizing and manipulating characteristics of digital audio tracks, the system comprising:
a computer with audio-input access and audio output capability;
audio content in a digital format including a plurality of audio tracks;
a color monitor connected to the computer;
user input devices including at least a computer keyboard, and a manually manipulable interface for controlling on-screen cursor activity;
audio recording software;
a gestural input device configured to accept input from a user of the system via manual gestures;
wherein the gestural input device is configured to control the audio recording software and alter at least one of a plurality of audio characteristics of one or more of the audio tracks, the alteration of the audio characteristics accomplished by one or more manual gestures by the user of the system;
wherein each audio track is presented to the user as an icon and the presentation of the icon corresponding to an audio track is based at least in part on the audio characteristics of the audio track defined by the user of the system; and,
wherein the position of the icon as presented to the user of the system represents a source of origin for the audio track to which the icon corresponds.

2. The system of claim 1, further comprising the gestural input device is a handheld device.

3. The system of claim 2, further comprising the gestural input device including motion sensors and configured to alter the audio track represented on the screen based on movements of the gestural input device, the gestural input device further configured to present a three dimensional representation of the plurality of audio tracks based on the source of origin of each sound track, wherein the user views this three dimensional representation with the user being centrally located among the sources of origin.

4. The system of claim 2, further comprising the handheld device is a tablet device with a touch screen display.

5. The system of claim 1, further comprising the icons associated with the sound tracks only being presented to the user of the system when the tracks are audible.

6. The system of claim 1, further comprising the lateral position of presentation of the icons to the user of the system representing the source of origin associated with the sound track corresponding to each icon and wherein multiple icons may be positioned vertically with respect to each other to represent multiple audio tracks originating from the same location.

7. The system of claim 1, further comprising the presentation of an icon corresponding to an audio track may be temporarily altered to represent a change in the audio characteristics of the audio track and wherein the icon returns to a default representation.
